(19) United States
(12) Patent Application Publication
(10) Pub. No.: US 2002/0038347 A1
(43) Pub. Date: Mar. 28, 2002

(54) Electronic mail distributing method and apparatus

(75) Inventor: Atsushi Maeda, Osaka (JP)

Correspondence Address: LYON & LYON LLP, 633 WEST FIFTH STREET, SUITE 4700, LOS ANGELES, CA, 90071, US

(73) Assignee: SANYO ELECTRIC CO., LTD

(21) Appl. No.: 09/823,265

(22) Filed: Mar. 30, 2001

(30) Foreign Application Priority Data
Sep. 22, 2000 (JP) 2000-288659

(51) Int. Cl. G06F 15/16

(52) U.S. Cl. 709/206; 709/203

(57) ABSTRACT

An electronic mail distributing apparatus which automatically sends out electronic mail which is scheduled to arrive at a recipient at specified future date and time. A receiving unit receives the electronic mail which is scheduled to arrive at the recipient at specified future date and time. A mail database stores information in a manner such that the electronic mail is associated with the specified date and time. A detection unit detects an electronic mail to be sent out, by comparing the specified date and time with the present date and time. A retrieval unit retrieves the to-be-sent electronic mail detected in the detection unit, from the mail database. A transmitting unit sends out the thus retrieved electronic mail to the recipient at the date and time specified by the sender.

### BACKGROUND OF THE INVENTION

1. Field of the Invention

The present invention relates to method and apparatus which distribute electronic mail via a network.

2. Description of the Related Art

Wide spread of the Internet enables many users to make private and professional use of electronic mail in sending and receiving messages. The electronic mail, or e-mail, is communicated between users via a mail server. For example, an e-mail destined to a “user A” sent from a terminal is transmitted to a SMTP (Simple Mail Transfer Protocol) server which handles SMTP. The SMTP server judges whether to spool the e-mail or transfer it to another SMTP server, based on a domain included in the e-mail address of the user A. This is determined at the moment when the e-mail is received. In a case where the e-mail is to be transferred to another SMTP server, the e-mail is then transferred instantaneously. Thus, the e-mail is sent to a mail server handling the e-mail of the user A in a very short period of time.

However, instead of this timing at which the e-mail is sent to a recipient in a short period of time, there is a case where it is preferred depending on a content of the e-mail that the e-mail be reached to the recipient after a certain period of time passes. In that case, a user needs to send the e-mail exactly when the user wishes the recipient to read it.

### SUMMARY OF THE INVENTION

The present invention has been made in view of the foregoing circumstance, and an object thereof is to provide an electronic mail transmitting technique with high usability and increased convenience.

An electronic mail distributing apparatus according to the present invention stores temporarily electronic mail whose dispatch date and time are specified in advance, and is structured such that the electronic mail with the specified date and time is sent out on the specified date. Thus, the electronic mail reaches at a recipient on the specified date or date/time.

In a preferred embodiment of the present invention, the electronic mail distributing comprises: a receiving unit which receives an electronic mail scheduled to be sent to a recipient at a specified date and time; a mail storing unit which stores the electronic mail received by the receiving unit; a detection unit which detects an electronic mail whose specified date and time becomes the present date and time; a retrieval unit which retrieves the electronic mail detected by the detection unit, from the mail storing unit; and a transmitting unit which sends the electronic mail retrieved by the retrieval unit.

In another embodiment of the present invention, the electronic mail distributing apparatus may further comprise a confirmation unit which confirms that the specified date and time to be sent out is set to one after the present data and time, and which then stores the electronic mail in the mail storing unit.

Moreover, the electronic mail distributing apparatus may further comprise a generating unit which generates header information of the electronic mail retrieved by the retrieval unit.

Moreover, any arbitrary combination of the above-mentioned structural components in the present invention is still effective as an embodiment of the present invention when applied to among apparatus, method and system and so forth.

Moreover, this summary of the invention does not necessarily describe all necessarily features so that the invention may also be sub-combination of these described features.

### BRIEF DESCRIPTION OF THE DRAWINGS

FIG. 1 is a block diagram showing a structure of an electronic mail distribution system 200 including an electronic mail distributing apparatus 100 according to an embodiment of the present invention.

FIG. 2 is a functional block diagram of the electronic mail distributing apparatus 100.

FIG. 3 is a flowchart showing a process covering up to a stage where the electronic mail is stored in a mail database 106.

FIG. 4 is a flowchart showing a process covering up to a stage where the electronic mail stored in the mail database 106 is sent to a destination client 14 at the designated date and time.

FIG. 5 is an exemplary electronic mail formation screen displayed in a display unit of an originating client 12.

FIG. 6 shows an exemplary data structure of the mail database 106.

FIG. 7 shows an exemplary electronic mail containing designated date and time.

FIG. 8 shows an exemplary electronic mail shown in FIG. 7 when sent out.

### DETAILED DESCRIPTION OF THE INVENTION

The invention will now be described based on the preferred embodiments, which do not intend to limit the scope of the present invention, but exemplify the invention. All of the features and the combinations thereof described in the embodiment are not necessarily essential to the invention.

In an electronic mail distributing apparatus according to an embodiment of the present invention, an electronic mail or e-mail is stored in advance, so that the e-mail can be transmitted at specified date and time in place of a user. Thereby, for example, the e-mail distributing apparatus can notify the agenda of a conference the day before and send out an e-mail on the day of a person's birthday, and notify a renewal due date of a membership card before the expiration day of the validity time, and so forth.

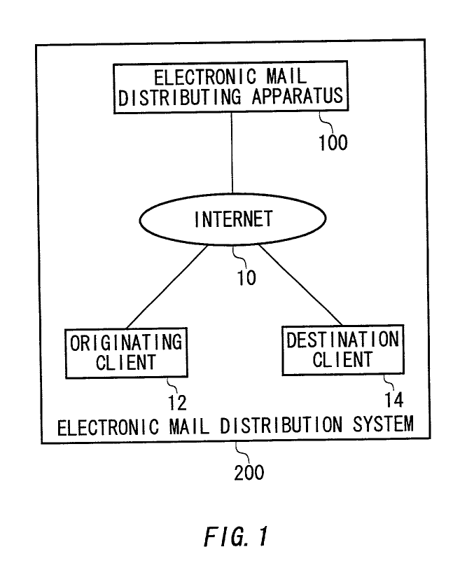

FIG. 1 is a block diagram showing a structure of an electronic mail distribution system 200 including an electronic mail distributing apparatus 100 according to an embodiment of the present invention. The electronic mail distributing apparatus 100 stores an electronic mail sent from an originating client 12 who is a sender of the electronic mail, and sends it to a destination client 14 on designated date and time. The electronic mail distributing apparatus 100 and the originating client 12 and the destination client 14 are connected to one another via the Internet 10.

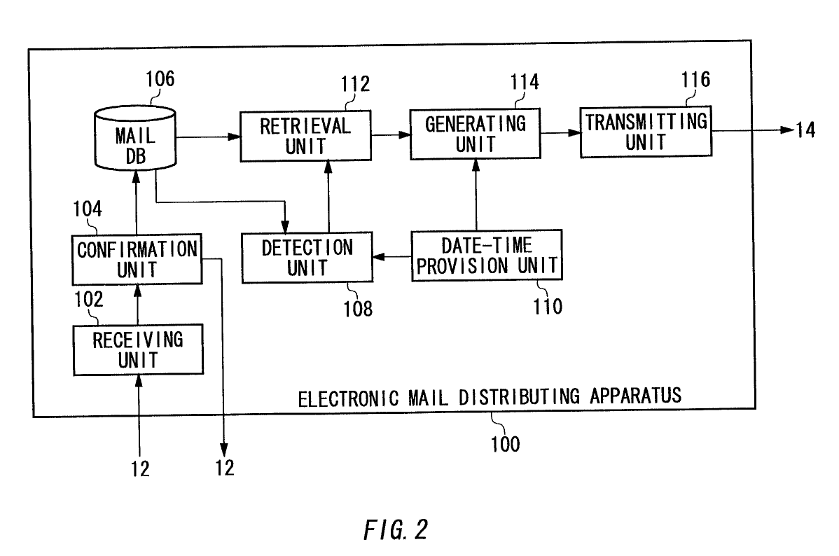

FIG. 2 is a functional block diagram of the electronic mail distributing apparatus 100. In terms of hardware components, the electronic mail distributing apparatus 100 is usually comprised mainly of and realized by a CPU, a memory and an electronic mail distributing program of an arbitrary computer. It is to be understood by those skilled in the art that the way to realize such the structure and a mode of the system may vary greatly. It is to be noted that FIG. 2 does not show a hardware-oriented structure but simply a function-oriented block diagram.

A receiving unit 102 receives the e-mail having the specified date and time sent from the originating client 12. The designated date and time may be attached to the e-mail or may be sent from the originating client 12 separated from the e-mail itself. A confirmation unit 104 confirms that the specified date and time is not before the present date and time. If the specified date and time is set to one before the present date and time, the confirmation unit 104 notifies the originating client 12 to the effect that the specified date and time was wrongly set. Moreover, if the specified date and time is set to one after the present date and time, the confirmation unit 104 stores it in a mail database 106 in a manner such that the e-mail corresponds to the specified date and time.

A date-time provision unit 110 provides the present date and time to a detection unit 108. Preferably, the date-time provision unit 110 provides not only the standard times of a plurality of countries where the electronic mail distributing apparatus 100 are set up, but also the local times of those countries to the detection unit 108. The detection unit 108 compares the standard time or local time provided by the time-date provision unit 110 with the designated date and time stored in the mail database 106, so as to identify and calculate a correspondence between the designated date/time and the electronic mail received. For example, in a case where an electronic mail is to be sent to a friend in the U.S. on his/her birthday, the date and time when the electronic mail is to be sent can be specified in compliance with the date and local time in the U.S. The detection unit 108 instructs a retrieval unit 112 to retrieve the electronic mail whose specified date and time becomes the present date and time.

The retrieval unit 112 supplies the thus retrieved electronic mail to a generating unit 114. The generating unit 114 generates a header portion of the electronic mail. Thereby, a time stamp is put on the electronic mail as if the electronic mail is sent from the originating client 12 on the specified date and time. A transmitting unit 116 sends out the electronic mail to the destination client 14.

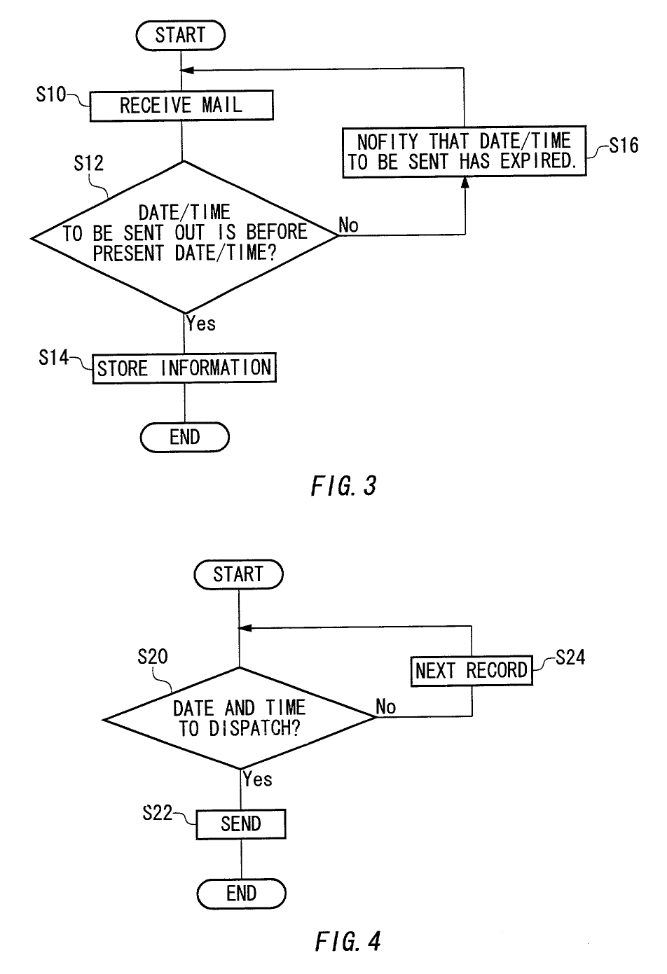

FIG. 3 is a flowchart showing a process covering up to a stage where the electronic mail is stored in a mail database 106. The receiving unit 102 receives an electronic mail sent from the originating client 12 (S10). The confirmation unit 104 judges whether or not the specified date and time has already passed (S12). When the specified date and time does not pass the present date and time (YES in S12), the mail database 106 stores the electronic mail in a manner such that the e-mail corresponds to the specified date and time. On the other hand, when the specified date and time has already passed the present date and time at the step S12 (NO in S12), the confirmation unit 104 notifies the originating client 12 accordingly (S16), thus preventing any incorrect specified date and time from being registered. The electronic mail distributing apparatus 100 repeats such processes of S10 through S16 every time the apparatus 100 receives an electronic mail, and stores in the mail database 106 in sequence in a manner that information on a single electronic mail is counted as a record or item.

FIG. 4 is a flowchart showing a process covering up to a stage where the electronic mail stored in the mail database 106 is sent to the destination client 14 at the designated date and time. The detection unit 108 compares the designated date and time with the present date and time provided by the date-time provision unit 110, and thereby judges per record whether or not the electronic mail is to be eligibly sent (S20). The retrieval unit 112 retrieves from the mail database 106 the electronic mail whose designated date and time become the present date and time. The generating unit 114 generates an electronic mail header. The transmitting unit 116 sends out the electronic mail to the destination client 14 (S22) if the present date and time becomes the specified date and time (YES in S20). On the other hand, if the present date and time does not yet become the specified date and time in the step S20 (NO in S20), the detection unit 108 judges the next record stored in the mail database 106 (S24). These processes are performed on each record in the order starting from the first record through the last record stored in the mail database 106. When the judging process is completed on the last record, the judging process resumes from the first record.

In the above judging process, time required for judgment on the first through last records increases as the number of the records increases. For example, in a case where the electronic mail is judged to be sent only if in the detection unit 108 the present date and time coincides with the designated date and time in the unit of a second, there might be electronic mail unsent which should have been sent. Thus, the detection unit 108 preferably judges so that a record whose specified date and time is after the present date and time is regarded as an electronic mail to be sent out.

Moreover, in order that the electronic mail can reach a mail server of the destination at specified date and time, the detection unit 108 may judge in a manner that the due date and time to be sent arrives when it is slightly before the exact designated date and time instead.

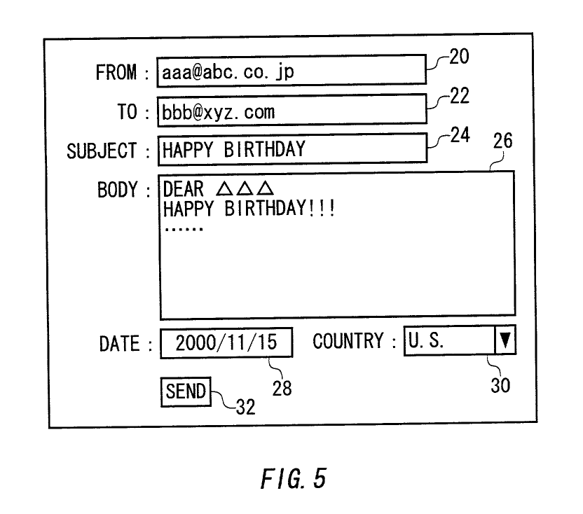

FIG. 5 is an exemplary electronic mail formation screen displayed in a display unit of an originating client 12. This formation screen is displayed at an e-mail recipient end as a WEB page. A transmission date inputting column 28 is a portion in which the specified date and time are inputted. Though the specified date only is inputted in FIG. 5, the time may be specified as well. A country selection column 30 specifies the standard time or local time for each country used in the detection unit 108. For example, if you wish to send out e-mail on Nov. 15, 2000 of the U.S. time, “2000/11/15” is inputted in the transmission date inputting column 28, and the U.S. is specified in the country selection column 30. A SEND button 32 instructs the electronic mail distributing apparatus 100 to dispatch the electronic mail containing the content inputted in these input columns.

When the user clicks on the SEND button 32, the originating client 12 sends out the content inputted in the input columns to the electronic mail distributing apparatus 100 via HTTP (Hyper Text Transfer Protocol). The electronic mail distributing apparatus 100 stores the received content in the mail database 106.

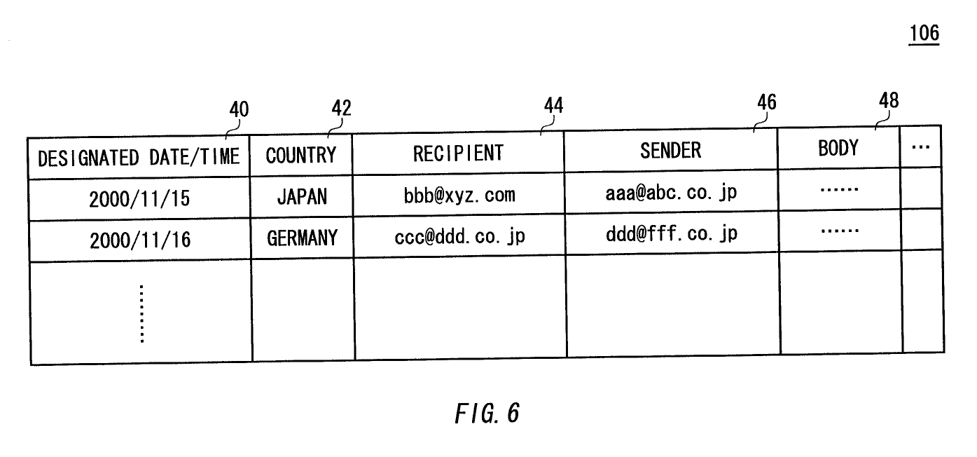

FIG. 6 shows an exemplary data structure of the mail database 106. The mail database 106 includes a designated date-time column 40, a country column 42, a recipient column 44, a sender column 46 and a body column 48. The designated date-time column 40 holds the date and time of the e-mail to be sent. In an example shown in FIG. 6, the e-mail to “bbb@xyz.com” scheduled to be sent on Nov. 15, 2000. The mail database 106 stores a plurality of records while single information on an e-mail is regarded as a record.

The present invention has been described based on the embodiments which are only exemplary. It is understood by those skilled in the art that there exist other various modifications to each component and the combination of each processing described and that such modifications are encompassed by the scope of the present invention. Such the modifications include the following.

Modifications

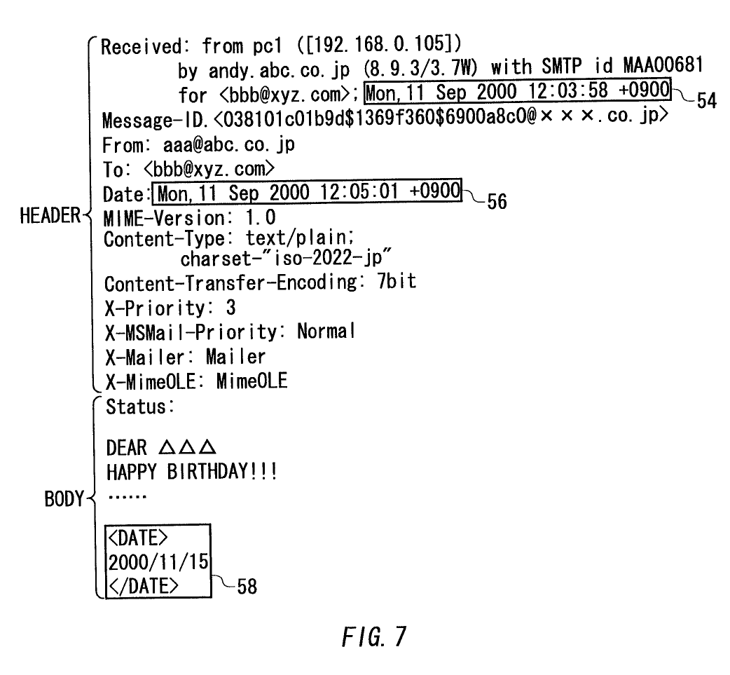

In a case where the transmission date and time of the electronic mail is specified by the conventional electronic mail client software, the user may implement a scheme in which the specified date and time are included in the body of the electronic mail. FIG. 7 shows an exemplary electronic mail containing designated date and time. The specified date and time are entered using a designated date-time tag 58. A portion enclosed by a tag <DATE> and a tag </DATE> indicates the specified date and time. The receiving unit 102 reads the specified date and time based on the tag which indicates the specified date and time in the body of the electronic mail. When the receiving unit 102 reads out the specified date and time, the receiving unit 102 supplies it to the confirmation unit 104. The confirmation unit 104 stores it in the mail database 106 in a manner such that the specified date and time is associated with the electronic mail. In this mode, the date/time and the electronic mail may be stored as the integrated information where the date/time is associated with the electronic mail.

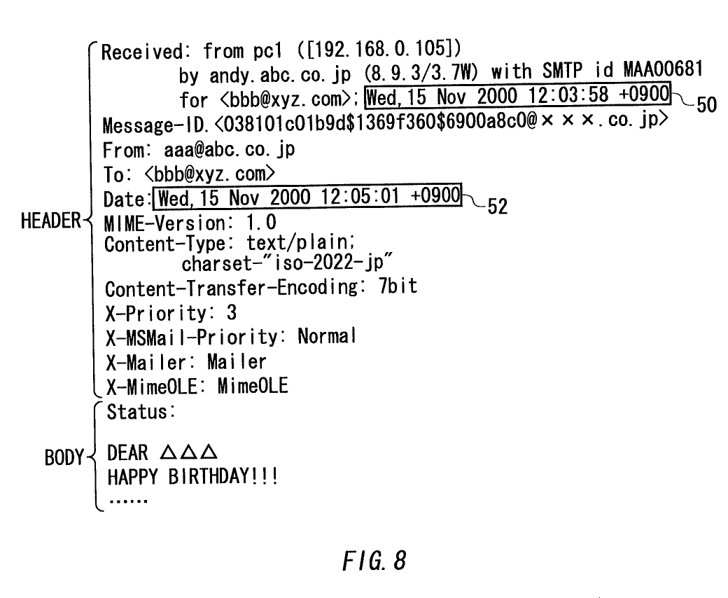

When the electronic mail stored in the mail database 106 is sent out, the generating unit 114 changes the time stamp of the electronic mail header while the specified date and time entered in the body is deleted. FIG. 8 shows an exemplary electronic mail shown in FIG. 7 when sent out. The time stamps 54 and 56 shown in FIG. 7 are changed to time stamps 50 and 52 bearing the date of Nov. 15, 2000. Moreover, the specified date-time tag is deleted. According to this scheme, the user can specify a date and time of the electronic mail to be sent, by using the conventionally available electronic mail client software.

In the above embodiments, for each electronic mail to be sent, the specified date and time is compared to the present date and time. However, the electronic mails may be sorted out in the order starting from one bearing the earliest date and time specified. In that case, it suffices to check the time on a single electronic mail whose specified date and time comes first.

According to the present embodiments, achieved is an electronic mail transmitting technique with high usability and increased convenience.

Although the present invention has been described by way of exemplary embodiments, it should be understood that many changes and substitutions may be made by those skilled in the art without departing from the spirit and the scope of the present invention which is defined by the appended claims.

What is claimed is:

1. An electronic mail distributing apparatus, comprising:
a receiving unit which receives an electronic mail scheduled to be sent to a recipient at a specified date and time;
a mail storing unit which stores the electronic mail received by said receiving unit;
a detection unit which detects an electronic mail whose specified date and time becomes the present date and time;
a retrieval unit which retrieves the electronic mail detected by said detection unit, from said mail storing unit; and
a transmitting unit which sends the electronic mail retrieved by said retrieval unit.

2. An electronic mail distributing apparatus as recited in claim 1, further comprising a confirmation unit which confirms that the specified date and time to be sent out is set to one after the present data and time, and which then stores the electronic mail in said mail storing unit.

3. An electronic mail distributing apparatus as recited in claim 1, further comprising a generating unit which generates header information of the electronic mail retrieved by said retrieval unit.

4. An electronic mail distributing apparatus as recited in claim 2, wherein said detection unit detects an electronic mail whose specified date and time is set to one slightly before the exact specified date and time.

5. An electronic mail distributing apparatus as recited in claim 1, wherein a data structure of said mail storing unit includes a specified date and time column, a destined country column, a recipient address column, a sender address column and a message body column.

6. An electronic mail distributing apparatus as recited in claim 2, further comprising a receiving unit which receives the electronic mail and reads out the specified date and time and which supplies it to said confirmation unit, wherein the specified date and time are entered in a body of an electronic mail message using a tag indicative thereof and said receiving unit reads the specified date and time based on the tag, and wherein the tag is deleted when the electronic mail is sent to the recipient.

7. A method of distributing electronic mail, comprising:
receiving an electronic mail scheduled to be sent to a recipient at a specified date and time;
storing the electronic mail received;
detecting an electronic mail stored whose specified date and time becomes the present date and time;
retrieving the electronic mail as a result of said detecting, from the stored electronic mails; and
transmitting the electronic mail as a result of said retrieving.

8. A method of distributing electronic mail, comprising:
receiving an electronic mail sent from an originating client;
judging whether or not date and time specified by the originating client are effective, and notifying the originating client if the specified date and time has already passed the present date and time so as to prevent wrong registration of the electronic mail;
storing the electronic mail when the specified date and time indicates future date and time; and
sending the stored electronic mail on the specified date and time to a recipient.

9. An electronic mail distributing apparatus as recited in claim 2, further comprising a generating unit which generates header information of the electronic mail retrieved by said retrieval unit.

10. An electronic mail distributing apparatus as recited in claim 1, wherein the apparatus is implemented in a mail server.

11. An electronic mail distributing apparatus as recited in claim 2, wherein the apparatus is implemented in a mail server.

12. An electronic mail distributing apparatus as recited in claim 3, wherein the apparatus is implemented in a mail server.
